(19) United States
(12) Patent Application Publication
(10) Pub. No.: US 2007/0097476 A1
(43) Pub. Date: May 3, 2007

(54) Display system having a charge-controlled spatial light-modulator

(76) Inventors: Martha A. Truninger, Corvallis, OR (US); Melinda Valencia, Corvallis, OR (US); Steve P. Hanson, Corvallis, OR (US); Loreli M. Fister, Corvallis, OR (US); Arjang Fartash, Corvallis, OR (US); George Radominski, Corvallis, OR (US); Timothy R. Emery, Corvallis, OR (US); Robert W. Shreeve, Moscow, ID (US); Matthew Rocha, Corvallis, OR (US); Alexander Govyadinov, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,856

(22) Filed: Oct. 28, 2005

(51) Int. Cl. G02F 1/03

(52) U.S. Cl. 359/245

(57) ABSTRACT

A display system includes a housing having at least one optical window and at least one charge-controlled spatial light-modulator disposed within the housing. The at least one spatial light-modulator is configured to project an image-bearing light beam to a viewing surface through the at least one optical window. The system further includes at least one electron gun selectively positioned at a predetermined angle with respect to the at least one spatial light-modulator. The electron gun is configured to project an electron beam into the housing to impinge a front surface of the at least one spatial light-modulator.

### BACKGROUND

Display devices, such as televisions, projectors, monitors, and camcorder viewfinders employ a variety of methods for generating images onto a viewing surface. Some of the more common approaches include using spatial light-modulators, such as Digital Light Processing (“DLP”) chips and Liquid Crystal Based Panel Displays (“LCD”) to modulate light beams before projecting a resultant image onto a viewing surface. One of the more recent developments in this area of emerging technologies is a light-modulation device containing an array of pixel elements composed of micro-electromechanical system (MEMS) devices. In general, MEMS devices are microscopic mechanical devices fabricated using integrated circuit manufacturing technologies. The mechanical structures within a MEMS device are generally flexible or otherwise moveable over a limited range of motion.

In a known light-modulation device, MEMS pixel elements include microscopic mirrors (“micromirrors”) with spring-like mechanisms configured to define “ON” states, wherein incident light is reflected from a micromirror to a spot (pixel) on the viewing surface, and “OFF” states, wherein incident light is diverted away from the viewing surface, generally to a light dump. In this way, a micromirror is in an “ON” state when tilted toward incident light, and in an “OFF” state when tilted away from incident light. In some cases, a display device includes an electron gun that projects an electron beam onto a front side of the pixel element, perpendicular to the surface of the micromirror, or alternatively, to the back-side of the pixel element. In both cases an “ON” state is driven by an electron beam that induces a charge on the micromirror and into an “OFF” state by passive resistive elements. The electron beam induces an electrostatic charge that attracts and tilts the micromirror towards a transmissive conductive substrate beneath the micromirror. When the electron beam is removed and the charge dissipated, the spring-like mechanism restores the micromirror to its original position. The problem, however, is that by arranging the electron gun normal to the surface of the pixel and by projecting the electron beam to the back side of the pixel element, the electron path is partially obstructed by the spring-like mechanism that is often integrated into the micromirror. This obstruction reduces the optical quality of each pixel by altering the induced electrostatic charge and by limiting the available pixel area. In addition, by having the spring-like mechanism the same material as the micromirror, the MEMS designer is limited by geometry and material selection. The embodiments described hereinafter were developed in light of these and other drawbacks.

### BRIEF DESCRIPTION OF THE DRAWINGS

The present embodiments will now be described, by way of example, with reference to the accompanying drawings, in which:

FIG. 1 illustrates an exemplary embodiment of a display system;

FIG. 2 illustrates another exemplary embodiment of a display system;

FIG. 3 illustrates a portion of an exemplary embodiment of an array of pixel elements;

FIG. 4 illustrates an exemplary embodiment of an enlarged partial view of a pixel element according to FIG. 3;

FIG. 5 is a flow diagram illustrating exemplary steps for constructing the pixel element of FIG. 4; and

FIGS. 6A-6H illustrate portions of an exemplary embodiment of a pixel element according to the exemplary flow diagram of FIG. 5.

### DETAILED DESCRIPTION

A display system for projecting an image-bearing light beam onto a viewing surface is provided. The system includes a device housing, an electron gun, and a spatial light-modulator that is mounted within the device housing. The spatial light-modulator is configured to project the image-bearing light beam onto the viewing surface through an optical window in the device housing. The electron gun is selectively positioned at a predetermined angle with respect to the spatial light-modulator such that a generated electron beam strikes a front face of the spatial light-modulator at the predetermined angle.

The spatial light-modulator includes an array of pixel elements composed of micro-electromechanical system (MEMS) devices that are configured into an array of charge-controlled micromirrors. Each pixel element includes two conducting layers (i.e., a micromirror and a hinge) and a conducting substrate. The electron gun projects a stream of electrons that impinge the surface of the micromirror inducing a charge thereon. The charged micromirror is pulled by an electrostatic force to the grounded conducting substrate thereby tilting the micromirror to a position that reflects an “ON” or an “OFF” state. While being bombarded with electrons, the charge on the micromirror slowly drains through a resistor in the conducting substrate. When the electron beam is removed, the charge eventually decays through the resistor, allowing a restoring hinge mechanism to release the micromirror to its original position.

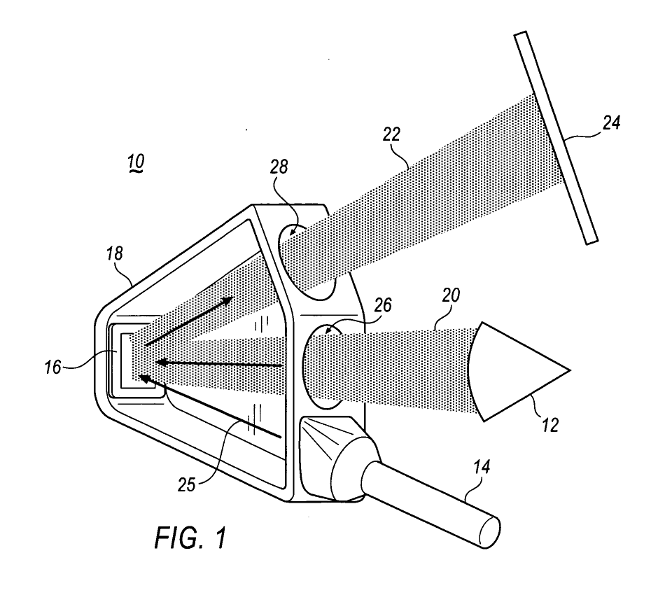

FIG. 1 illustrates an exemplary display device 10 including a light source 12, an electron gun 14, and a spatial light-modulator 16 disposed within a device housing 18. Although shown in FIG. 1 with an open surface, the device housing 18 is an enclosed structure that is generally constructed of glass. However, other materials such as ceramic, stainless steel, or any material capable of sustaining a high vacuum internal pressure is also suitable. The spatial light-modulator 16 includes an array of pixel elements configured to modulate incoming light 20 from light source 12 to generate an image-bearing light beam 22 that ultimately impinges onto a viewing surface 24. The electron gun 14 is selectively positioned at a predetermined angle with respect to the spatial light-modulator 16 such that an electron beam 25, emanating from the electron gun 14, impinges a top surface of the pixel elements in the spatial light-modulator 16. An optical window 26 in the glass housing 18 directs the incoming light 20 from light source 12 to the spatial light-modulator 16. The glass housing 18 further includes another optical window 28 for projecting the modulated image-bearing light beam 22 from the spatial light-modulator 16 to the viewing surface 24. In one embodiment, the optical window 28 may additionally include a lens system (not shown).

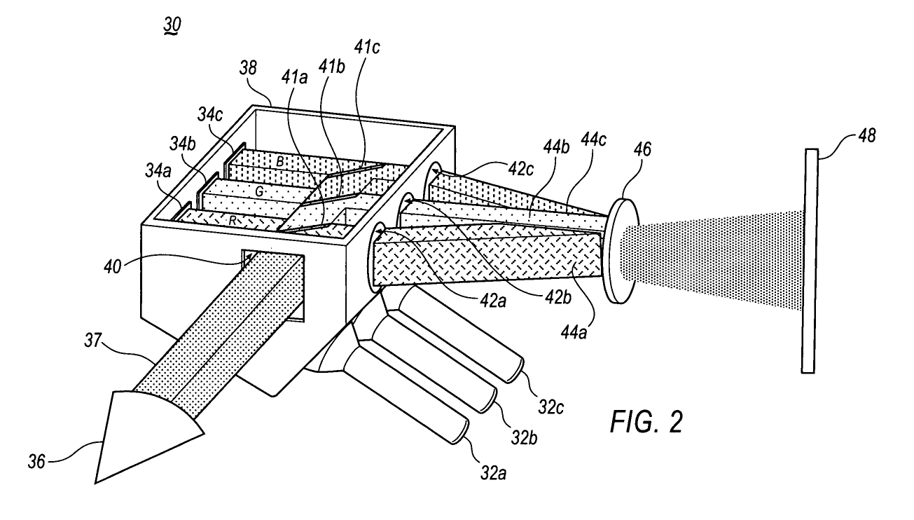

Alternatively, the glass housing 18 can be modified to accommodate a multiple colored system 30, as shown in FIG. 2, wherein there are three electron guns (32a, 32b, and 32c) and three spatial light-modulators (34a, 34b, and 34c), one for each of the primary colors red, green, and blue. Similar to the single electron gun configuration of FIG. 1, a light source 36 projects a light beam 37 into the device housing 38 through an optical window 40. The difference, however, is that the light beam 37 is directed to three dichroic filters 41a, 41b, and 41c that separate the incoming light beam 37 into three individually colored light beams of red (R), green (G) and blue (B). Each of the colored light beams R, G, and B are then directed to dedicated spatial light-modulators 34a, 34b, and 34c.

Like the display device of FIG. 1, the electron guns 32a, 32b, and 32c are selectively positioned at a predetermined angle with respect to each of the spatial light-modulators 34a, 34b, and 34c. The device housing 38 further includes three optical windows 42a, 42b, and 42c for projecting the modulated image-bearing light beams 44a, 44b, and 44c to a lens 46, and ultimately to a viewing surface 48. In one embodiment, each of the optical windows 42a, 42b, and 42c may additionally include a lens or optical beam converging system (not shown). In addition, reflective or refractive optical elements such as dichroic or total internal reflection (TIR) beam splitting cubes may be included into the glass housing 38 to recombine the individual colored light beams, R, G, and B into a single full color image-bearing light beam that projects onto the viewing surface 48 through a single optical window (not shown). Although equally applicable, for purposes of explanation, the description hereinafter refers only to the exemplary components of the single gun configuration of FIG. 1.

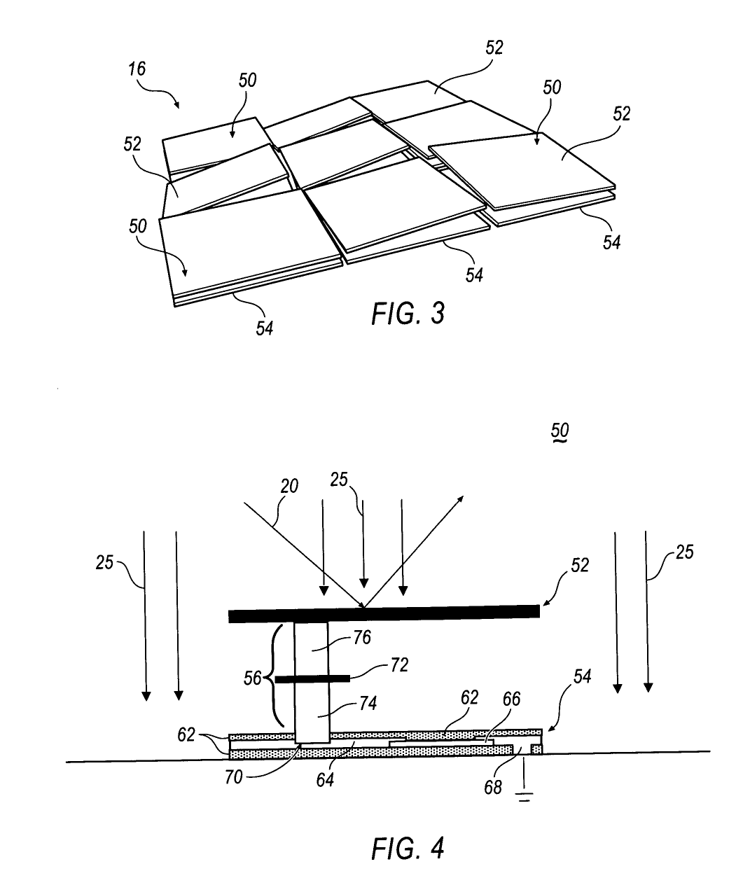

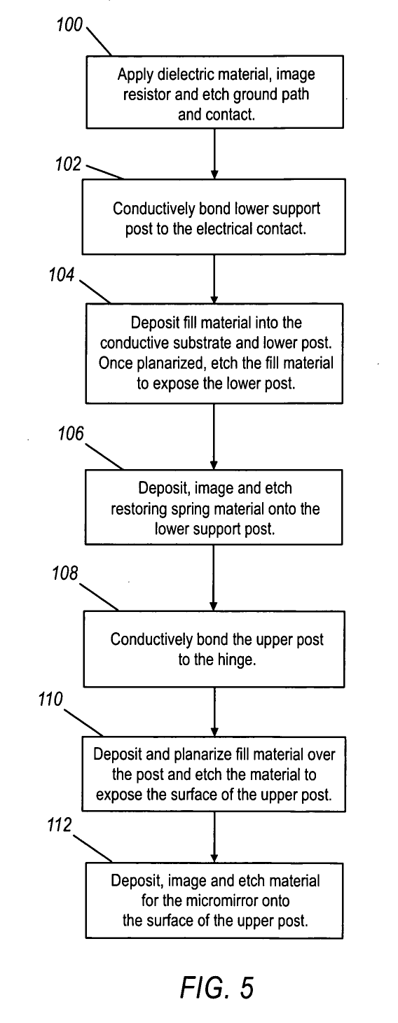

FIG. 3 is a portion of an exemplary spatial light-modulator 16 illustrating an array of pixel elements 50 having deformable micromirrors 52 on a conducting substrate 54. FIG. 4 illustrates an enlarged side view of an exemplary pixel element 50 having a deformable micromirror 52 and a conducting substrate 54 with a restoring hinge mechanism 56 therebetween. The micromirror 52 and the conducting substrate 54 are electrically connected by the restoring hinge mechanism 56. The transparent or non-transparent material for forming the conductive substrate 54 may include, but is not limited to, quartz, glass, sapphire, and silicon. The top and bottom surfaces of the conductive substrate 54 are generally coated with a dielectric material 62 such that a resistive path 64 is defined therebetween. Within the resistive path 64 is a resistor 66. Etched into the surface of the dielectric material 62 is a conductive ground path 68 and a contact 70 that electrically connects the restoring hinge mechanism 56 to the resistive path 64. Restoring hinge mechanism 56 includes a hinge 72 that is electrically connected to the conductive substrate 54 and the micromirror 52 by a lower post 74 and an upper post 76, respectively. The lower and upper posts 74, 76 are generally formed of a conductive or semi-conductive material. The hinge 72 may be constructed as a single or multilayer film. The material used to form the hinge 72 may be a metallic conductive material, or a resistive conducting material depending on the specific application and design criteria. Specific material examples include, but are not limited to, single alloy films or multi-layer films of Ta—Al, W—Al, Ti—Al, Ni—Al, Cr—Al, Al—Cu, Mo—Al, Mb—Al, V—Al, Ta—Cu, W—Cu, Ta—Si, W—Si, Ti—Si, Ni—Si, Co—Si, Cr—Si, Mo—Cu, Mb—Cu, V—Cu, Mo—Si, Mb—Si, and V—Si.

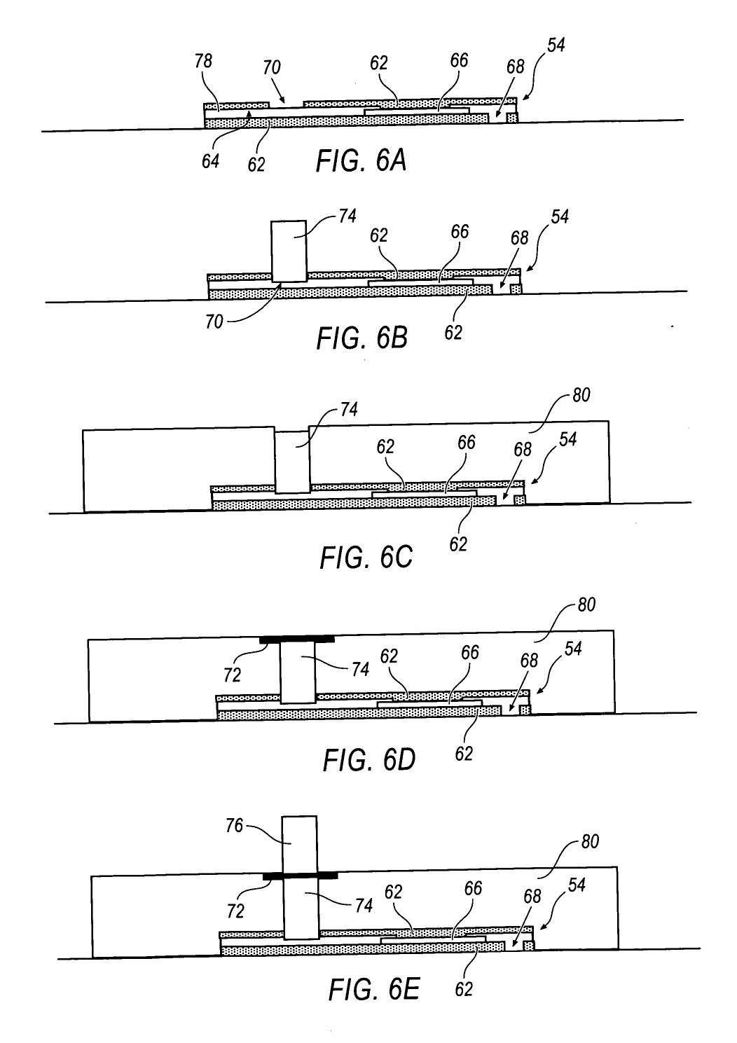

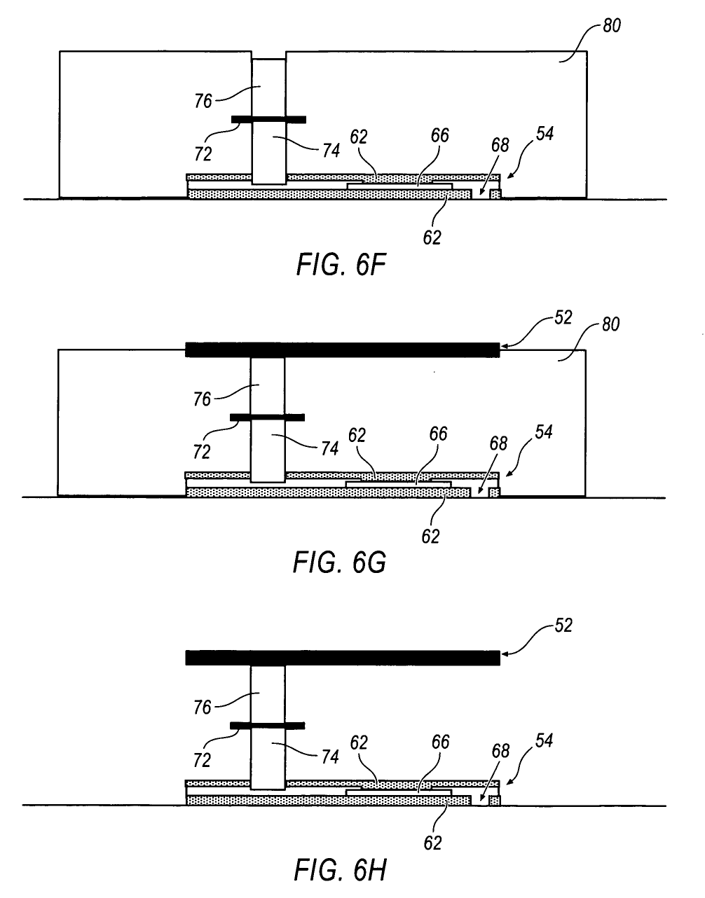

FIG. 5 is a flow diagram illustrating a set of exemplary steps for constructing a pixel element 50 according to the exemplary structure shown in FIG. 4. References to physical components refer to the exemplary components illustrated in FIGS. 1 and 4, and FIGS. 6A-6H. Referring first to FIG. 6A, at step 100 the conductive substrate 54 is constructed by first building a resistor 66 into a conducting material 78, and then by applying a coating of dielectric material 62 to both the upper and lower surfaces of the conducting material 78. In addition, a ground path 68 and a contact 70 are etched into the dielectric material 62. Accordingly, a resistive path 64 is defined between the layers of dielectric material 62 and the conductive substrate 54. At step 102, and referring to FIG. 6B, the lower post 74 makes a conductive contact to the contact 70 of the conductive substrate 54. At step 104, and as shown in FIG. 6C, a fill material 80 is deposited and planarized onto the conductive substrate 54 and lower post 74. The fill material 80 is subsequently etched to expose the surface of the lower post 74.

Referring to FIG. 6D, at step 106 the material for the hinge 72 is deposited, imaged, and etched onto the lower post 74. At step 108, the upper post 76 is conductively bonded to the hinge 72 as shown in FIG. 6E. At step 110, and referring to FIG. 6F, additional fill material 80 is deposited and planarized over the upper post 76. Subsequently, the fill material 80 is etched to expose the surface of the upper post 76.

Further, with reference to FIGS. 6G and 6H, at step 112 the material for the micromirror 52 deposited, imaged, and etched onto the surface of the upper post 76, and the fill material 80 is removed.

Referring to FIGS. 1 and 4, in operation the electron gun 14 and the light source 12 cooperatively project an electron beam 25 and a light beam 20, respectively, onto the surface of the spatial light-modulator 16. The electron beam 25 induces a charge on the micromirror 52 such that the micromirror 52 becomes electrostatically drawn to, or tilted toward, the conductive substrate 54 causing the pixel element 50 to be in one of either an “ON”, or an “OFF” state. When in the “ON” state, the micromirror is titled toward the light beam 20 thereby reflecting the incident light beam onto the viewing surface 24. Conversely, when in an “OFF” state, the micromirror 52 is generally tilted away from the incident light beam 20, reflecting no light back to the viewing surface 24. While being bombarded with electrons, the charge on the micromirror slowly drains through the resistive path 64 and the resistor 66 to the ground path 68 in the conducting substrate 54. After the electron beam 24 is removed the micromirror discharges over time and the restoring hinge mechanism 56 releases the micromirror 52 to its original neutral position. The amount of time it takes for the micromirror 52 to fully discharge is determined by the amount of charge induced on the micromirror 52 by the electron beam 25, and the resistance value of the resistive path 64.

While the present invention has been particularly shown and described with reference to the foregoing preferred embodiment, it should be understood by those skilled in the art that various alternatives to the embodiments of the invention described herein may be employed in practicing the invention without departing from the spirit and scope of the invention as defined in the following claims. It is intended that the following claims define the scope of the invention and that the method and system within the scope of these claims and their equivalents be covered thereby. This description of the invention should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A display system, comprising:
a housing having at least one optical window;
at least one charge-controlled spatial light-modulator disposed within said housing, said at least one spatial light-modulator is configured to project an image-bearing light beam to a viewing surface through said at least one optical window; and
at least one electron gun selectively positioned at a predetermined angle with respect to said at least one spatial light-modulator, said at least one electron gun is configured to project an electron beam into said housing to impinge a front surface of said at least one spatial light-modulator.

2. The display system of claim 1, wherein said at least one spatial light-modulator includes an array of pixel elements, comprising:
a micromirror; and
a conductive substrate electrically connected to said micromirror by a restoring hinge mechanism;
wherein said electron beam impinges a top surface of said micromirror inducing a charge thereon.

3. The display system of claim 2, wherein said restoring hinge mechanism includes a lower post, an upper post, and a hinge disposed therebetween.

4. The display system of claim 2, wherein said conductive substrate includes a contact for electrically connecting said restoring hinge mechanism to said conductive substrate.

5. The display system of claim 2, wherein at least a portion of said conductive substrate is coated with a dielectric material.

6. The display system of claim 2, wherein said conductive substrate includes one of the following materials: quartz, glass, sapphire and silicon.

7. The display system of claim 2, wherein said restoring hinge mechanism includes conductive or semi-conductive materials.

8. The display system of claim 2, wherein said conductive substrate includes a resistive path that electrically connects said restoring hinge mechanism to a ground path.

9. The display system of claim 2, wherein said conductive substrate includes a resistor that electrically connects said micromirror to a ground path through said restoring hinge mechanism.

10. A spatial light-modulator having a plurality of pixel elements, comprising:
a micromirror; and
a conductive substrate electrically connected to said micromirror by a restoring hinge mechanism;
wherein an electron beam impinges a top surface of said micromirror at a predetermined angle inducing a charge thereon.

11. The spatial light-modulator of claim 10, wherein said restoring hinge mechanism includes a lower post, an upper post, and a hinge disposed therebetween.

12. The spatial light-modulator of claim 10, wherein said conductive substrate includes a contact for electrically connecting said restoring hinge mechanism to said conductive substrate.

13. The spatial light-modulator of claim 10, wherein at least a portion of said conductive substrate is coated with a dielectric material.

14. The spatial light-modulator of claim 10, wherein said conductive substrate includes one of the following materials: quartz, glass, sapphire and silicon.

15. The spatial light-modulator of claim 10, wherein said restoring hinge mechanism includes conductive or semi-conductive materials.

16. The spatial light-modulator of claim 10, wherein said conductive substrate includes a resistive path that electrically connects said restoring hinge mechanism to a ground path.

17. The display system of claim 10, wherein said conductive substrate includes a resistor that electrically connects said micromirror to a ground path through said restoring hinge mechanism.

18. A display system, comprising:
a housing having at least one optical window;
at least one charge-controlled spatial light-modulator disposed within said housing, said at least one spatial light-modulator is configured to project an image-bearing light beam to a viewing surface through said optical window; and
at least one electron gun, selectively positioned at a predetermined angle with respect to said at least one spatial light-modulator, said at least one electron gun is configured to project an electron beam into said housing to impinge a front surface of said at least one spatial light-modulator;
wherein said at least one spatial light-modulator includes an array of pixel elements, comprising:
a micromirror; and
a conductive substrate electrically connected to said micromirror by a restoring hinge mechanism;
wherein said electron beam impinges a top surface of said micromirror inducing a charge thereon.

19. A method of constructing a pixel element in a spatial light-modulator comprising the steps of:
imaging a conductive substrate;
imaging an electrical contact on said conductive substrate;
imaging a restoring hinge mechanism on said conductive substrate; and
imaging a micromirror on said restoring hinge mechanism wherein imaging said restoring hinge mechanism includes:
imaging a lower post on said conductive substrate at said electrical contact;
imaging a hinge on a top portion of said lower post; and
imaging an upper post on a top portion of said hinge.

20. The method of claim 19, wherein the step of imaging said conductive substrate further comprises the steps of:
imaging a ground path; and
imaging a resistive path between said electrical contact and said ground path.

21. The method of claim 20, wherein the step of imaging said resistive path further comprises building a resistor in said resistive path.

22. The method of claim 19, wherein the step of imaging said hinge further comprises depositing a fill material onto said conductive substrate and said lower post.

23. The method of claim 19, wherein the step of imaging said micromirror further comprises the step of depositing a fill material onto said conductive substrate, said lower post, said hinge, and said upper post.

24. The method of claim 23, further comprising the step of removing said fill material.

25. A method for projecting an image-bearing light beam onto a viewing surface, comprising:
providing a spatial light-modulator having a plurality of charge-controlled pixel elements, comprising:
a micromirror; and
a conductive substrate electrically connected to said micromirror by a restoring hinge mechanism;
projecting an electron beam to said spatial light-modulator at a predetermined angle with respect to a front face of said spatial light-modulator; and
impinging said electron beam onto a top surface of said micromirror inducing a charge thereon.

26. The method of claim 25, further comprising the step of tilting said micromirror toward said conductive substrate in response to said electron beam inducing a charge thereon.

27. The method of claim 26, further comprising the step of removing said electron beam and discharging the induced charge on said micromirror through said restoring hinge mechanism to a resistive path and a ground path in said conductive substrate.

28. A display system, comprising:
at least one spatial light-modulator having a plurality of charge-controlled pixel elements, each of said plurality of pixel elements includes a micromirror having a top reflective surface and a conductive substrate;
a means for directing a light beam onto said top reflective surface of said micromirror; and
a means for inducing a charge on said top reflective surface of said micromirror, wherein said induced charge pulls said micromirror to said conductive substrate.

29. The display system of claim 28, further comprising:
a means for discharging said induced charge through said conductive substrate to ground upon removal of said means for inducing said charge; and
a means for releasing said micromirror when said micromirror is fully discharged.
